(19) United States
(12) Patent Application Publication
(10) Pub. No.: US 2002/0152861 A1
(43) Pub. Date: Oct. 24, 2002

(54) Method and apparatus for cutting a cant into boards

(75) Inventor: Patrick M. Conry, Hot Springs, AR (US)

Correspondence Address: MANELLI DENISON & SELTER, 2000 M STREET NW SUITE 700, WASHINGTON, DC, 20036-3307, US

(73) Assignee: Hi-Tech Comact

(21) Appl. No.: 10/118,997

(22) Filed: Apr. 10, 2002

Related U.S. Application Data
(60) Provisional application No. 60/283,365, filed on Apr. 13, 2001.

(51) Int. Cl. B26D 5/00; B26D 3/00; B26D 7/06

(52) U.S. Cl. 83/56; 83/75.5; 83/155

(57) ABSTRACT

A cutting apparatus for cants of non-uniform original dimensions includes a pair of band saws at a cutting station through which a cant passes along a path; each band saw is mounted on a carriage that is mounted for movement relative to the path and actuating piston and cylinder devices are used to move each carriage in response to data fed to a control computer from a cant scan.

### FIELD OF THE INVENTION

The present the invention relates to an improvement in apparatus for cutting a log that has been canted into boards while maximizing the production of the boards from logs with a higher production efficiency than has heretofore been possible with certain prior art equipment. The invention also provides a method of operating the apparatus to optimize production and to provide boards of substantially uniform thickness even where the log exhibits a significant curvature along its longitudinal axis.

### BACKGROUND OF THE INVENTION

Due largely to the increasing scarcity of high quality lumber that is available for harvesting, it is becoming increasingly important that the processes employed to cut logs into boards be able to accommodate a greater variety of initial log shapes at efficient production speeds whereby logs that normally would be discarded due to their curvature or other defects will be able to be harvested and efficiently cut into useful wood products. In prior U.S. Pat. No. 5,722, 474 an apparatus and method are disclosed where disk saws are mounted on an axle which in turn is mounted on a pivotable support that is controlled by a computer to permit optimization of the output of the device. A scanning station is employed to record the outer configuration of a canted log which data is fed to the computer to analyze the data obtained and to supply it to the computer operating software for controlling the position of the gang saws relative to a substantially rectilinear path of travel for the log. Ideally, each incoming log is scanned and a unique cutting solution for that log will be derived and utilized to control for each selected increment of length of the log the cutting position of the gang saws in correlation with the throughput speed of the transport conveyor for the log.

The chief advantage of the arrangement of the aforesaid U.S. patent is that logs that previously were discarded were able to be used to provide marketable wood products. In addition, the production capacity of the mill was increased significantly. However, in the lumber mill industry, there are a large number of installations that have already installed equipment including band type saws. Since the structures of these mill installations does not lend itself to economical adaptation to the curved log cutting techniques disclosed in U.S. Pat. No. 5,722, 474, it has become necessary for other solutions to the efficiency problem to be found.

### SUMMARY OF THE INVENTION

The present invention provides an apparatus and method of operation for a computer controlled the saw mill cutting operation where the cutting devices employed are band saws mounted on movable carriages and preferably located downstream of chipping devices which in one embodiment are mounted on pivotable carriages to allow the device to accommodate even severe curvature in the log product.

In a preferred form, each band saw is in the form of a continuous loop having an upper and lower guide pulley mounted on a carriage which in turn is mounted for reciprocation along a rectilinear path. To enhance the production capacity, chipping devices are mounted upstream of the band saws and are themselves preferably mounted on pivoting or shiftable carriages with the chipping devices movable along rectilinear paths on the pivoting carriages to allow the apparatus to accommodate different cant widths. With such an arrangement, a virtually finished cant can be delivered from the device.

The foregoing and other advantages of the present invention will become apparent as consideration is given to the following detailed description taken in conjunction with the attached drawings, in which:

### BRIEF DESCRIPTION OF THE DRAWINGS

FIG. 1 is a top, plan view of a portion of the band saw mill apparatus showing an infeed conveyor and a portion of the outfeed assembly;

FIG. 2 is a side view in elevation of the device of FIG. 1;

FIG. 3 is a top, plan view of another embodiment of the band saw mill apparatus of this invention;

FIG. 4 is a top plan view of another embodiment of the present invention;

FIG. 5 is a top plan view in schematic form of a further modification of the invention of FIG. 1; and

FIG. 6 is a top plan view of another modification of the present invention.

### DETAILED DESCRIPTION OF THE INVENTION

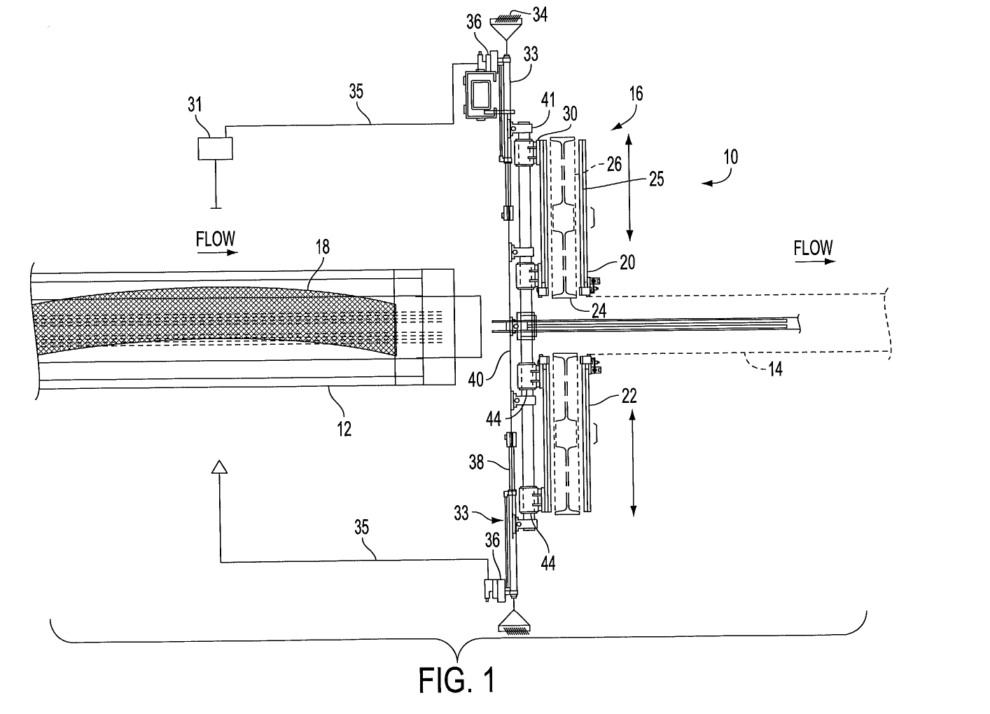

Referring to the drawings, wherein like numerals designate corresponding parts throughout the several views, there is shown in FIG. 1 a top plan schematic view of a band saw set up 10 which includes an infeed conveyor 12, an outfeed conveyor 14 and a band saw assembly 16. Other parts helpful to the understanding of the invention are not illustrated but are disclosed in U.S. Pat. No. 5,722, 474, the disclosure of which is incorporated herein by reference. The feed conveyor 12 will typically carry a cant 18 which, as shown, is severely curved along its longitudinal axis. The cant 18 is fed along with the conveyor 12 to a gap between two band saw assemblies 20 and 22 which are of substantially identical construction so that the following description of band saw assembly 20 will be understood to apply to assembly 22 as well.

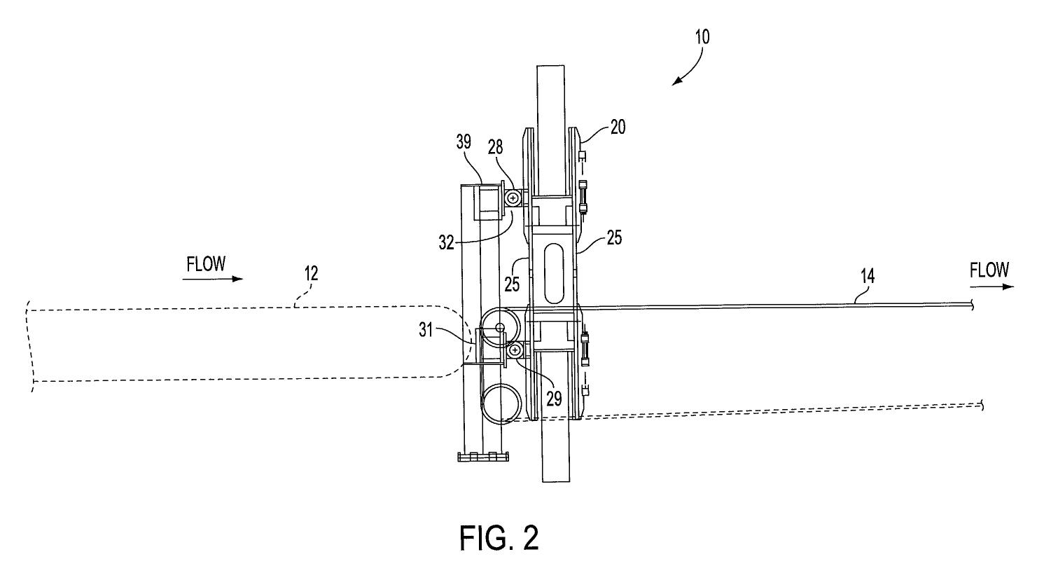

The band saw assembly 20 includes a band saw blade 26 which is in the form of a continuous loop extending about a support 24 which is carried at its center on plates 25. As is apparent from FIG. 2, the inner plate 25 is attached at its outer periphery to four slide brackets 30 and 32 which, in turn, are slidably mounted on a pair of vertically spaced apart rods 28, 29. In one embodiment, the brackets 30 and 32 may be fixed on rods 28 and 29 and the rods may be shifted by a piston rod 38 carried by a piston 33 so as to move the assembly 20 relative to the path of travel of the curved cant 18 as the curved cant 18 moves from the left to the right in FIG. 1 past the saw blades 26 of each saw assembly 20 and 22.

As will be apparent from the following discussion and to those skilled in this technology, a number of techniques are available for shifting the band saw assemblies 20 and 22 relative to the path of travel of the cant 18 from the conveyor 12 to the conveyor 14. For example, information from an optical scan of the cant 18 may be passed to a control system where computer 31 will analyze the scan information and perform the calculations as noted in U.S. Pat. No. 5,722,474 to determine the optimum cutting operation for the saws. The computer will then send electrical signals along a cable 35 to a linear positioning cylinder 36 to control the actuation of each of these cylinder pistons 33 of each assembly 20 and 22. A unique cutting solution will be derived by the software running in the computer 31 to optimize the positioning of the band saw assembly's 20 and 22 relative to the position of the cant 18 between the assemblies 20 and 22 and will take into consideration the velocity of travel of the cant 18 on the conveyor 12. As described more fully in the aforementioned U.S. patent, an efficient cutting operation will result with the movement of the band saw assemblies 20 and 22 determined by the incremental curvature of the cant 18. As a result, the expense of mounting a heavy gang saw arrangement for rapid pivoting movement during the travel of that of a cant is eliminated. As shown in FIG. 2, the rod 28 extends parallel to a lower support rod 29 which is provided with its slide brackets 30 parallel to the arrangement as shown in the top plan view of FIG. 1. The cylinders 32 and their actuation mechanisms 36 may be mounted on a post 39 at each outside periphery of the assembly 10.

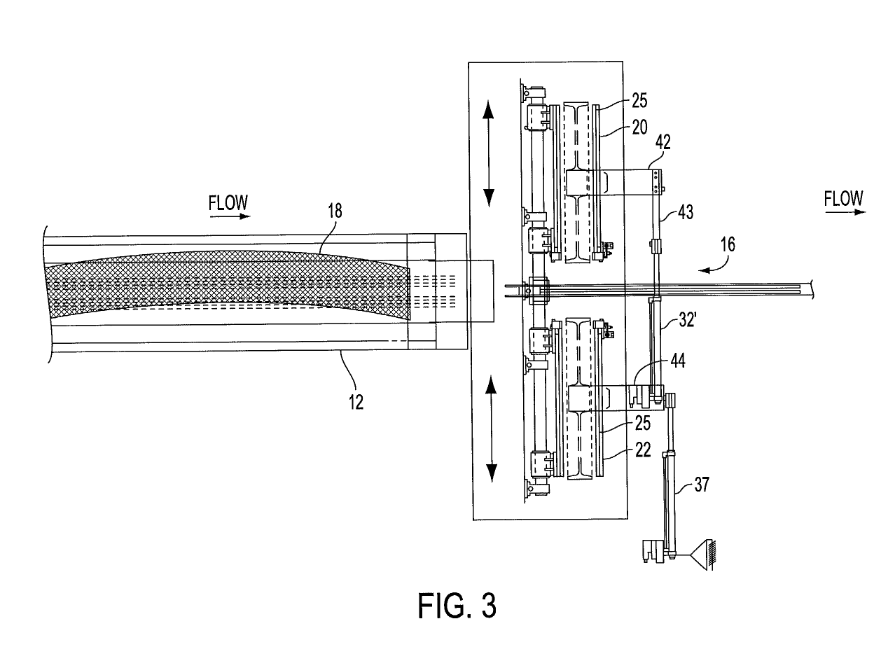

As shown in FIG. 3, another arrangement of the positioning cylinders 32 is shown where a single cylinder 32′ extends between two rigid legs 42 and 44 extending outwardly from the plates 25 of the respective band saw assemblies 20 and 22. The piston rod of the cylinder 32′ is connected to rigid arm 42, through an extension such as at 43, if needed, and will control the positioning of the two band saw assemblies 20 and 22 relative to each other. Another cylinder 37 with one end rigidly fixed to a support and also attached to arm 44 of one of the cylinders 32 permits positioning of the assembly 16 either with or without varying the position between the band saw assemblies 20 and 22.

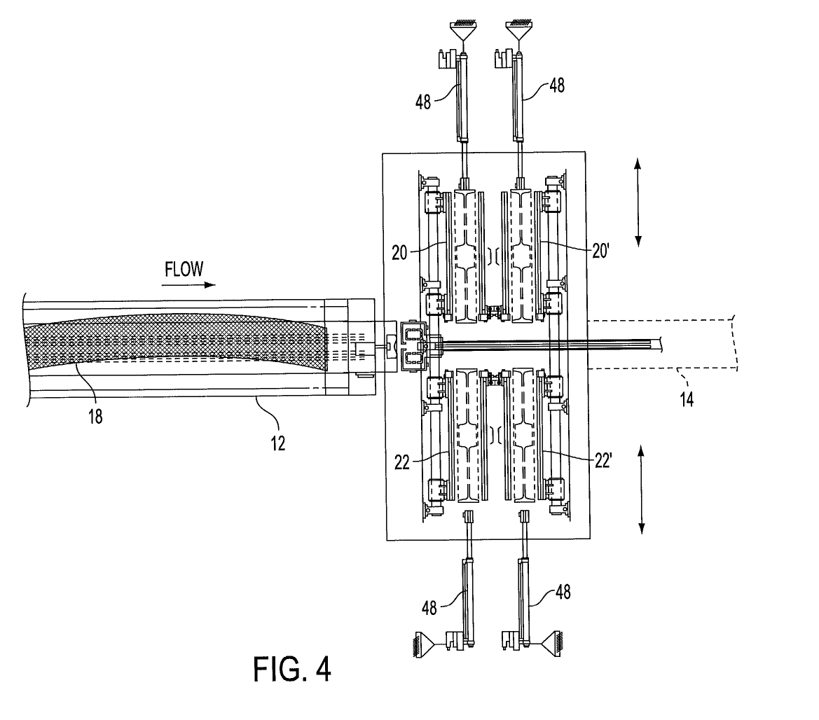

As shown in FIG. 4, to achieve greater flexibility in the cutting operation two pairs of the band saw assemblies are provided at 20, 20′, 22 and 22′. Each assembly will be provided with its own linear positioning piston and cylinder such as at 48 and these preferably are individually controlled in the same manner as the cylinders in the previous embodiments.

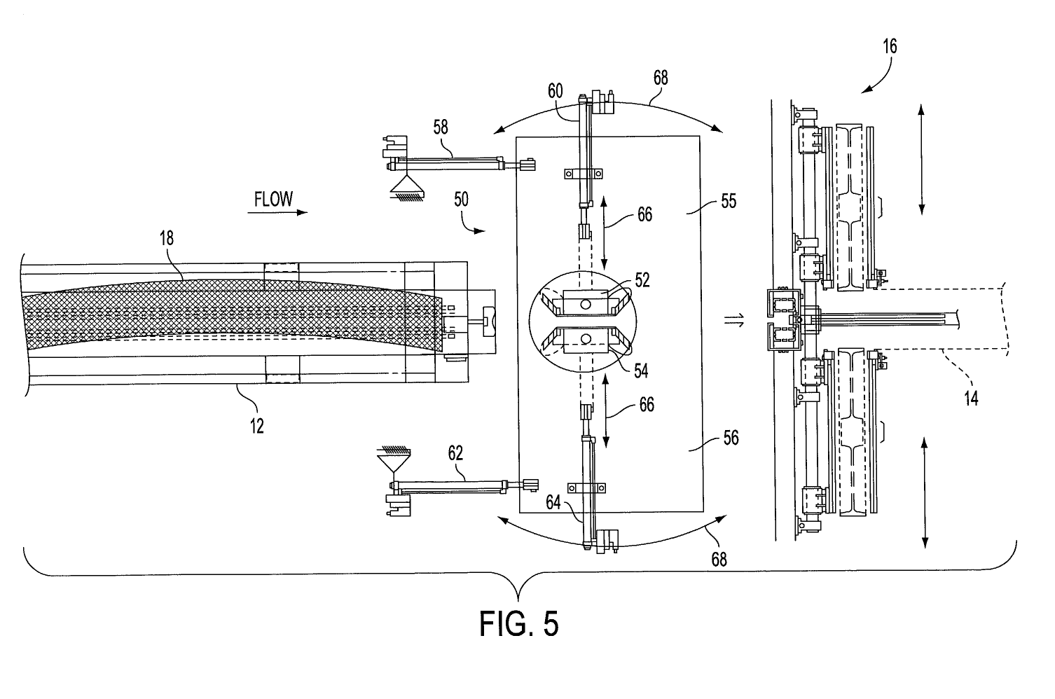

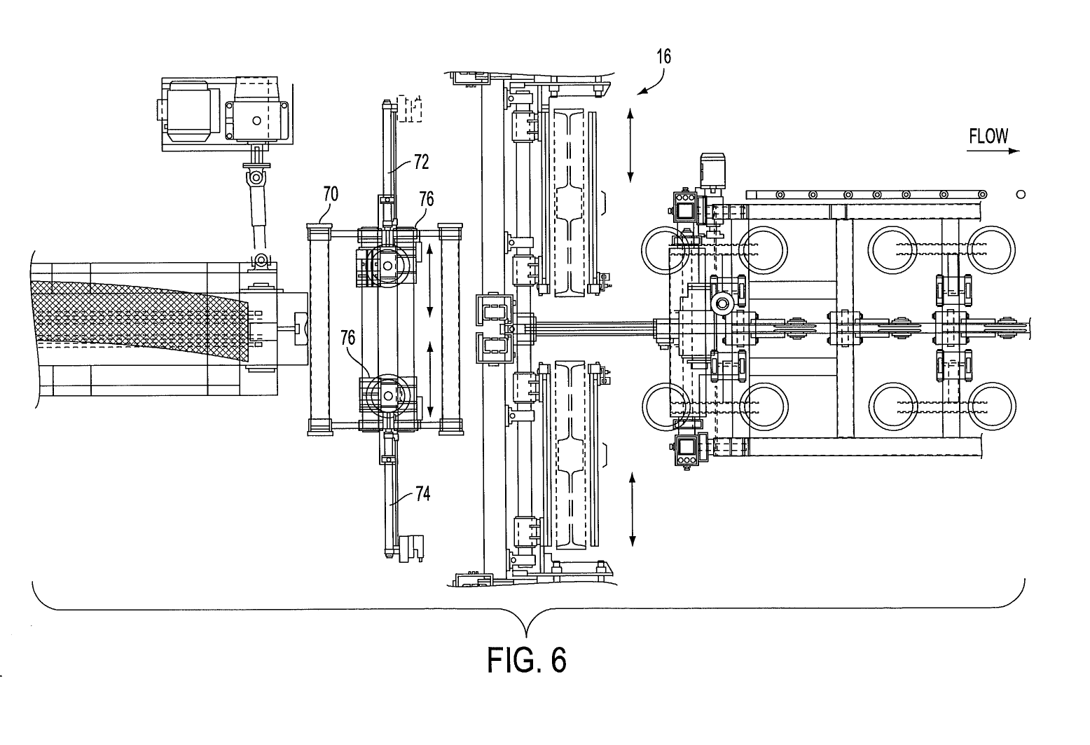

In handling almost all cants, it is preferable to provide complete finishing treatment of the log separate from the sawing operation alone and this involves separate equipment such as is illustrated in schematic form in FIGS. 5 and 6. In the arrangement of FIG. 5, a chipping platform 50 is located between the in feed conveyor 12 and the band saw assembly 16 and outfeed conveyor 14. To remove knots, bark or other imperfections from the side edges of the cant 18 stripping bands 52 and 54 are each mounted on separate platforms 55 and 56 each of which is movable by means of separate cylinders 58, 60, 62 and 64 to permit motion in the direction of arrows 66 as well as rotational motion as shown by the arrows 68. The cylinders 58-64 will typically be fluid actuated so that the 5 control is through the valves supplied from a source of fluid under pressure and the valving may be subjected to control by the same computer 33 that controls the positioning of the band saw assembly 16 since the basic information relative to that already obtained from the scanned cant 18 will be the source for the control signals to be fed to the cylinders 58-64.

As shown in FIG. 6, a somewhat more limited motion is achieved for the chipping apparatus mounted on a frame 70, the position of which is controlled by a pair of a piston and cylinders 72 and 74 upstream of the band saw assembly 16. The chipping devices 76 will be of conventional construction and will therefore not be further described.

What is claimed is:

1. An apparatus for cutting a workpiece into parts of desired dimensions where the workpiece has non-uniform original dimensions comprising:
a) transport conveyor apparatus for moving the workpiece along a path to and through a cutting station;
b) a cutting station including a pair of band saws each mounted on a separate support,
c) each support being mounted for movement toward and away from said path,
d) actuating members for moving each said support relative to said path.

2. The invention as claimed in claim 1 wherein each support includes a carriage carrying a said band saw, each carriage including a slide member and said cutting station having a support arm with each slide member engaging a said support arm.

3. The invention as claimed in claim 2 wherein said actuating members are piston and cylinder devices.

4. The invention as claimed in claim 1 wherein each support includes a carriage carrying a said band saw, each carriage including a bracket and said cutting station having a support arm on which each bracket is fixedly mounted, said actuating member being linked to said support arm for moving said support arm relative to said path.

5. The invention as claimed in claim 2 wherein two actuating members are provided, a first one of said actuating members including a cylinder linked to one of said carriages and a piston linked to the second one of said actuating members, the second one of said actuating members including a cylinder having a piston extendable therefrom and linked to said cylinder of said first one of said actuating members with said cylinder of said second one of said actuating members being fixed so that said carriages may be moved relative to said path together as well as separately relative to each other and said path.

6. The invention as claimed in claim 2 wherein a pair of support arms are provided for each carriage, said support arms being spaced apart from each other and each carriage having a first pair and a second pair of brackets with said first pair engaging one of said support arms of said pair of a said carriage and said second pair engaging the other of said support arms.

7. The invention as claimed in claim 6 wherein each support arm is a rod and each bracket is a sleeve surrounding a said respective rod.

8. The invention as claimed in claim 1 wherein another pair of band saws are provided downstream of said pair of band saws, with said pairs of band saws being spaced apart along said path, each band saw being mounted on a said separate support.

9. The invention as claimed in claim 8 wherein said actuating members are piston and cylinder devices.

10. The invention as claimed in claim 8 wherein a pair of support arms are provided for each carriage, said support arms being spaced apart from each other and each carriage having a first pair and a second pair of brackets with said first pair engaging one of said support arms of said pair of a said carriage and said second pair engaging the other of said support arms.

11. The invention as claimed in claim 10 wherein said chipping apparatus includes a table carrying said chipping apparatus, said table being mounted for movement relative to said path and actuating members being provided which are linked to said table to effect movement thereof.

12. The invention as claimed in claim 8, wherein, along said path, a chipping apparatus is provided upstream of said cutting station.

13. The invention as claimed in claim 1 wherein, along said path, a chipping apparatus is provided upstream of said cutting station.

14. The invention as claimed in claim 13 wherein said chipping apparatus includes a table carrying said chipping apparatus, said table being mounted for movement relative to said path and actuating members being provided which are linked to said table to effect movement thereof.

15. A method of cutting a workpiece into pieces smaller than the original workpiece size comprising the steps of:
a) scanning the workpiece to generate data corresponding to its dimensions and shape;
b) feeding the workpiece along a path to a cutting station having a pair of band saw cutting devices mounted adjacent the path so as to be movable toward and away from the path, and actuating members for moving each cutting device relative to said path;
c) supplying the data to a computer to derive a cutting solution, with said computer being connected to said actuating members,
d) using the data to control the movement of said actuating members to effect a desired cutting of the workpiece.
